(19) United States
(12) Patent Application Publication
(10) Pub. No.: US 2026/0264175 A1
(43) Pub. Date: Sep. 10, 2026

(54) LASER PROCESSING APPARATUS AND METHOD FOR MANUFACTURING LASER-PROCESSED PRODUCT [AS AMENDED]

(71) Applicant: TOWA CORPORATION, Kyoto-shi, Kyoto (JP)

(72) Inventors: Takuya MOGAMI, Sagamihara-shi, Kanagawa (JP); Hiroki OKAWA, Sagamihara-shi, Kanagawa (JP); Takayuki MIHARA, Sagamihara-shi, Kanagawa (JP)

(73) Assignee: TOWA CORPORATION, Kyoto-shi, Kyoto (JP)

(21) Appl. No.: 19/166,838

(22) PCT Filed: Dec. 5, 2023
(86) PCT No.: PCT/JP2023/043452

§ 371 Date: Sep. 18, 2025

(30) Foreign Application Priority Data
Mar. 20, 2023 (JP) 2023-044158

(51) Int. Cl. B23K 26/50; B23K 26/16

(52) U.S. Cl. CPC B23K 26/50; B23K 26/16

(57) ABSTRACT

A laser processing apparatus capable of laser processing while efficiently aspirating dust is obtained. The laser processing apparatus comprises: a stage; an outer peripheral wall portion disposed so that a hollow space extends from a side closer to the stage toward a side farther therefrom; a cylindrical wall portion that sectionalizes the hollow space into an inner space and an outer space; an irradiation unit that emits laser light o pass through the inner space to irradiate a workpiece; a transparent member provided to close the inner space; and a lid member having a first opening and disposed to close the outer space between the cylindrical wall portion and the outer peripheral wall portion, and the cylindrical wall portion has a second opening at a position on the side closer to the stage than the transparent member is.

### TECHNICAL FIELD

The present specification relates to a laser processing apparatus and a method for manufacturing a laser processed product.

### BACKGROUND ART

When a laser processing apparatus applies laser processing to a workpiece, the workpiece produces fine dust. When a large amount of dust is present on a surface of the workpiece or in a space between a laser irradiation unit and the workpiece, laser light's energy is attenuated, which may for example result in a processing rate deviating from a desired value. As disclosed in Japanese Patent Laying-Open No. 2013-006200 (PTL 1), an aspiration device is generally used to exhaust dust.

### CITATION LIST

### Patent Literature

PTL 1: Japanese Patent Laying-Open No. 2013-006200

### SUMMARY OF INVENTION

### Technical Problem

It is an object of the present specification to disclose a laser processing apparatus capable of laser processing while efficiently aspirating dust, and a method using such a laser processing apparatus to apply laser processing to a workpiece for manufacturing a laser processed product.

### Solution to Problem

According to the present disclosure, a laser processing apparatus applies laser processing to a workpiece, and the laser processing apparatus comprises: a stage that receives the workpiece thereon; an outer peripheral wall portion that forms a hollow space inside thereof and is disposed so that the hollow space extends from a side closer to the stage toward a side farther from the stage; a cylindrical wall portion that has a cylindrical shape and is disposed in the hollow space to sectionalize the hollow space into an inner space located inside the cylindrical shape and an outer space located outside the cylindrical shape; an irradiation unit that emits laser light so that the laser light passes through the inner space from the farther side toward the closer side and irradiates the workpiece; a transparent member that is provided so as to close the inner space at a position on the farther side away from an end portion of the cylindrical wall portion located on the closer side; and a lid member that has a first opening and is disposed so as to close the outer space between the cylindrical wall portion and the outer peripheral wall portion, wherein the outer space communicates with an aspiration device, the laser processing produces dust, which is aspirated through the first opening and the outer space, and a cross-sectional area of a channel of the first opening is smaller than a cross-sectional area of a channel of the outer space between the cylindrical wall portion and the outer peripheral wall portion, and the cylindrical wall portion has a second opening at a position on the closer side than the transparent member.

According to the present disclosure, a method for manufacturing a laser processed product uses the laser processing apparatus described above, and the method comprises irradiating the workpiece disposed on the stage with laser light.

### Advantageous Effects of Invention

The thus configured laser processing apparatus can perform laser processing while efficiently aspirating dust.

### BRIEF DESCRIPTION OF DRAWINGS

FIG. 1 is a schematic cross section of a laser processing apparatus 100 according to a first embodiment.

FIG. 2 is a perspective view of a configuration in cross section of a lid member 10, a cylindrical wall portion 20, an outer peripheral wall portion 30, and a top plate member 70 that laser processing apparatus 100 comprises according to the first embodiment.

FIG. 3 is another perspective view of lid member 10, cylindrical wall portion 20, outer peripheral wall portion 30, and top plate member 70 that laser processing apparatus 100 comprises according to the first embodiment.

FIG. 4 is a cross section taken along a line IV-IV indicated in FIG. 2.

FIG. 5 is a schematic cross section of laser processing apparatus 100 while performing laser processing according to the first embodiment.

FIG. 6 shows a lid member 10A that a laser processing apparatus comprises according to a second embodiment.

FIG. 7 shows a cylindrical wall portion 20A that a laser processing apparatus comprises according to a third embodiment.

FIG. 8 is a schematic cross section of a laser processing apparatus 100A according to a fourth embodiment.

FIG. 9 is a schematic cross section of a laser processing apparatus 100B according to a fifth embodiment.

FIG. 10 is a diagram showing a degree of scattering of dust on the stage as a result of a first verification experiment.

FIG. 11 is a diagram showing a degree of scattering of dust on the stage as a result of a second verification experiment.

### DESCRIPTION OF EMBODIMENTS

Hereinafter, embodiments of the present disclosure will be described. In the embodiments described below, when a number, an amount, etc. are referred to, the scope of the present disclosure is not necessarily limited to the number, the amount, etc. unless otherwise specified. Each component is not necessarily essential to the present disclosure unless otherwise specified. Identical or equivalent components are identically denoted and may not be described repeatedly.

### First Embodiment

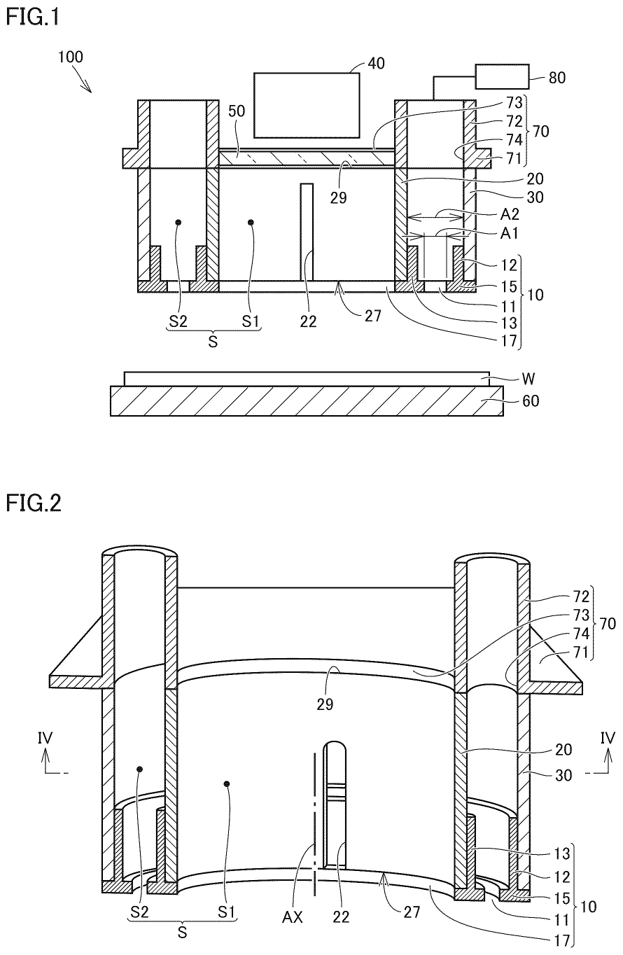

A laser processing apparatus 100 according to a first embodiment will now be described with reference to FIGS. 1 to 5. Laser processing apparatus 100 can manufacture a laser processed product by applying laser processing to a semiconductor wafer or a similar workpiece W (see FIGS. 1 and 5).

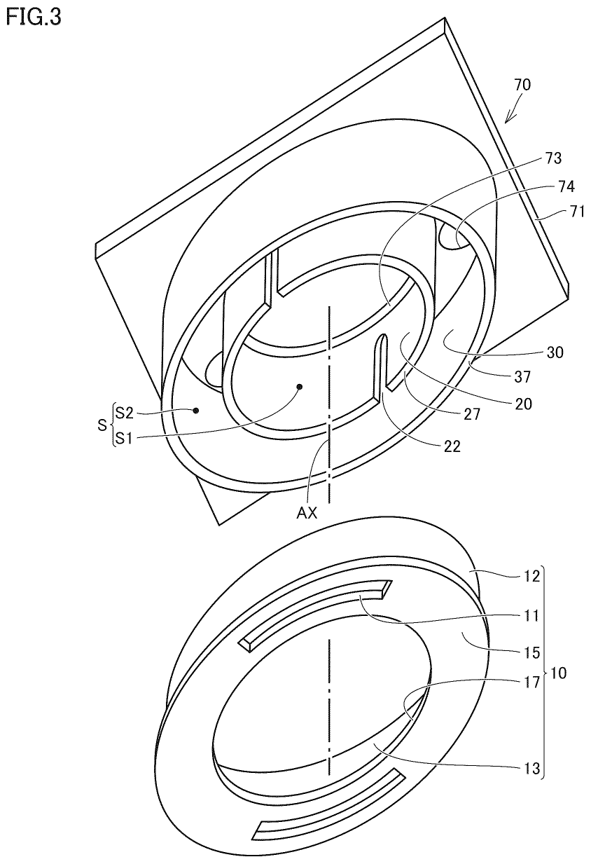

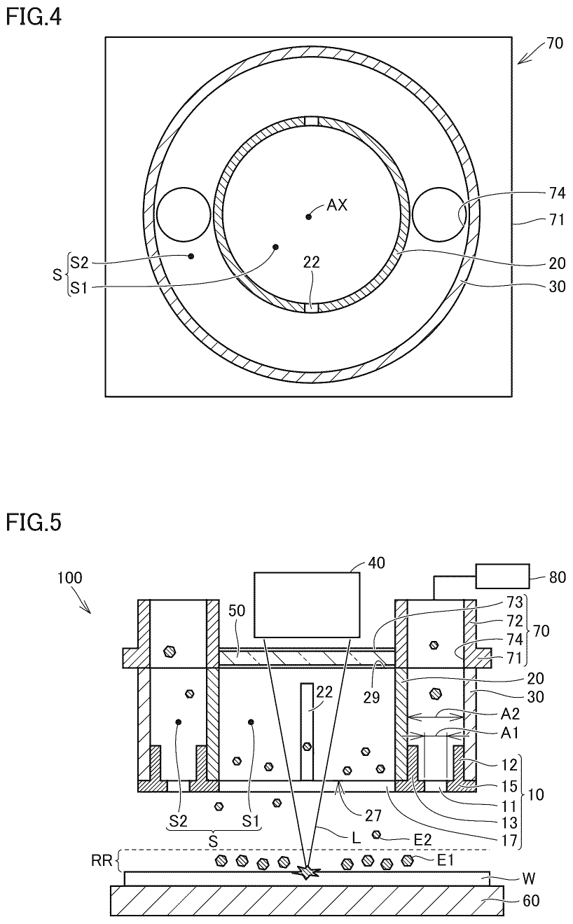

FIG. 1 is a schematic cross section of laser processing apparatus 100. FIG. 2 is a perspective view of a configuration in cross section of a lid member 10, a cylindrical wall portion 20, an outer peripheral wall portion 30, and a top plate member 70 that laser processing apparatus 100 comprises. FIG. 3 is another perspective view of lid member 10, cylindrical wall portion 20, outer peripheral wall portion 30, and top plate member 70 that laser processing apparatus 100 comprises, with lid member 10 removed from cylindrical wall portion 20 and outer peripheral wall portion 30. FIG. 4 is a cross section taken along a line IV-IV indicated in FIG. 2.

As shown in FIG. 1, laser processing apparatus 100 comprises a stage 60, an irradiation unit 40, lid member 10, cylindrical wall portion 20, outer peripheral wall portion 30, a transparent member 50, and top plate member 70. Workpiece W is disposed on a surface of stage 60, and irradiation unit 40 emits laser light toward workpiece W to irradiate the workpiece with the laser light. As an example of laser processing, stage 60 with workpiece W disposed thereon is moved while irradiation unit 40 emits laser light. As another example of laser processing, a position at which irradiation unit 40 irradiates workpiece W with light is changed while stage 60 is fixed.

### (Outer Peripheral Wall Portion 30)

As shown in FIGS. 2 to 4 (FIG. 3, in particular), outer peripheral wall portion 30 generally has a circularly cylindrical shape and forms a hollow space S inside outer peripheral wall portion 30. Outer peripheral wall portion 30 extends along a cylinder axis AX from an end portion 37 (see FIG. 3) located on a side where stage 60 (see FIG. 1) is disposed toward a side where top plate member 70 is disposed.

Outer peripheral wall portion 30 is not limited to a circularly cylindrical shape and may have any shape, such as a rectangular shape, a polygonal shape, or an elliptical shape, that can form hollow space S inside thereof. Furthermore, outer peripheral wall portion 30 is not limited in shape to a “cylinder” and may have any shape that has a shape of an outer peripheral wall that sectionalizes and thus forms hollow space S. Outer peripheral wall portion 30 is disposed so that hollow space S extends from the side closer to stage 60 toward a side farther therefrom.

### (Cylindrical Wall Portion 20)

As shown in FIG. 3, cylindrical wall portion 20 has a cylindrical shape. Cylindrical wall portion 20 is disposed in hollow space S and sectionalizes hollow space S into an inner space S1 and an outer space S2. Inner space S1 is located inside the cylindrical shape of cylindrical wall portion 20, and outer space S2 is located outside the cylindrical shape of cylindrical wall portion 20.

As shown in FIGS. 1 to 3, inner space S1 has a circularly columnar shape. Inner space S1 is also formed so as to extend from the side closer to stage 60 toward the side farther therefrom. Outer space S2 has a circularly cylindrically extending shape. Outer space S2 is also formed so as to extend from the side closer to stage 60 toward the side farther therefrom.

Cylindrical wall portion 20 has an end portion 27 at a position on the side closer to stage 60. End portion 27 is formed generally in an annular shape. As will more specifically be described hereinafter, lid member 10 has a first opening 11, and cylindrical wall portion 20 has a second opening 22. Second opening 22 is formed so as to penetrate cylindrical wall portion 20 in the direction of its thickness from a side of an inner peripheral surface of cylindrical wall portion 20 toward a side of an outer peripheral surface of the cylindrical wall portion. Laser processing produces dust, which is aspirated through inner space S1 and second opening 22 (see FIG. 5).

Laser processing apparatus 100 has second opening 22 in a shape that opens at end portion 27 of cylindrical wall portion 20. In other words, second opening 22 is formed to have a length or a shape that reaches end portion 27. This configuration is not essential, and second opening 22 may have a shape of a through hole that penetrates cylindrical wall portion 20 at a position away from end portion 27.

Laser processing apparatus 100 has second opening 22 in a shape extending in the form of a slit from the side closer to stage 60 (that is, a side closer to end portion 27) toward the side farther therefrom. The form of a slit is a shape of a hole having a transverse cross section (a cross section orthogonal to a flow of a fluid or the like) having a length and a width, the length being sufficiently larger than the width. Specifically, it may be in the form of a rectangle, an ellipse, an elongated hole, etc. These configurations are not essential, either, and second opening 22 may have a circular shape or the like and may not be formed to extend linearly.

As shown in FIGS. 3 and 4, laser processing apparatus 100 has cylindrical wall portion 20 in a circularly cylindrical shape about cylinder axis AX and provided with a plurality of (herein, two) second openings 22. The plurality of second openings 22 are provided at positions symmetrical with respect to cylinder axis AX. This configuration can also be employed when cylindrical wall portion 20 has a rotationally symmetrical shape. Being “rotationally symmetrical” as referred to herein means a property of repeating the same geometry at an angle of rotation of 2 π/n radians, n being a positive integer, when a portion of cylindrical wall portion 20 is rotated about cylinder axis AX. These configurations are not essential, either, and the plurality of second openings 22 may be provided to cylindrical wall portion 20 at any position.

### (Top Plate Member 70)

Top plate member 70 is disposed so as to close outer space S2 between cylindrical wall portion 20 and outer peripheral wall portion 30 from above. Top plate member 70 includes a flat plate portion 71, two exhausting portions 72, a hole 73, and two aspiration ports 74. The two exhausting portions 72 project from flat plate portion 71, and aspiration port 74 is provided inside exhausting portion 72. Hole 73 is provided so as to penetrate flat plate portion 71, and transparent member 50 is provided inside hole 73.

Top plate member 70 is positioned so that the two aspiration ports 74 communicate with outer space S2. Outer space S2 has a major portion covered with flat plate portion 71. Outer space S2 also communicates with an aspiration device 80 (see FIG. 1) through aspiration port 74 and exhausting portion 72. Aspiration port 74 that communicates with aspiration device 80 is positionally not limited to such a configuration, and, for example, outer peripheral wall portion 30 may be provided with an aspiration port having a similar function and communicating with aspiration device 80.

### (Lid Member 10 and First Opening 11)

As shown in FIG. 3, lid member 10 has first opening 11 as described above, and is disposed so as to close outer space S2 between cylindrical wall portion 20 and outer peripheral wall portion 30. For example, lid member 10 includes a bottom plate portion 15, an outer cylindrical portion 12, an inner cylindrical portion 13, first opening 11, and a communication hole 17. Bottom plate portion 15 is in the form of a disk, and has a center provided with communication hole 17 in the form of a circle so as to penetrate the bottom plate portion in the direction of its thickness.

Outer cylindrical portion 12 and inner cylindrical portion 13 are provided so as to erect from bottom plate portion 15, and outer cylindrical portion 12 is disposed outside inner cylindrical portion 13 so as to surround inner cylindrical portion 13. Laser processing apparatus 100 has bottom plate portion 15 provided with two first openings 11. First opening 11 is located in a radial direction about cylinder axis AX between outer cylindrical portion 12 and inner cylindrical portion 13.

Lid member 10 is positioned so that outer cylindrical portion 12 and inner cylindrical portion 13 are inserted between cylindrical wall portion 20 and outer peripheral wall portion 30. Outer space S2 has a major portion covered with bottom plate portion 15. Outer space S2 also communicates through the two first openings 11 with a space in which stage 60 and workpiece W are disposed.

Laser processing apparatus 100 has lid member 10 provided with a plurality of (herein, two) first openings 11. The plurality of first openings 11 are disposed at positions symmetrical with respect to cylinder axis AX. Each first opening 11 extends in a circumferential direction about cylinder axis AX. These configurations are not essential, either, and the plurality of first openings 11 may be provided to bottom plate portion 15 at any position in any shape.

The space in which stage 60 and workpiece W are disposed communicates with aspiration device 80 through first opening 11 and outer space S2. Laser processing produces dust, which is aspirated by aspiration device 80 through first opening 11 and outer space S2. In a cross section orthogonal to a flow of a fluid or the like, first opening 11 provides a channel having a cross-sectional area A1 (see FIG. 1) and outer space S2 between cylindrical wall portion 20 and outer peripheral wall portion 30 provides a channel having a cross-sectional area A2 (see FIG. 1), and cross-sectional area A1 is sufficiently smaller than cross-sectional area A2.

### (Irradiation Unit 40)

Irradiation unit 40 employs any optical system (not shown), such as an oscillator, a mirror, and a lens, to emit laser light L (see FIG. 5) toward workpiece W. Irradiation unit 40 emits laser light L so that laser light L travels from the side farther from stage 60 toward the side closer thereto and laser light L also passes through inner space S1 and irradiates workpiece W.

### (Transparent Member 50)

As shown in FIG. 1, transparent member 50 is provided so as to close inner space S1. As has been described above, cylindrical wall portion 20 has end portion 27 at a position on the side closer to stage 60. Transparent member 50 is provided so as to close inner space S1 at a position away from end portion 27 of cylindrical wall portion 20 toward the side farther from stage 60.

Laser processing apparatus 100 has transparent member 50 disposed inside hole 73 provided through top plate member 70. Transparent member 50 may not be disposed at a position inside hole 73 insofar as it is provided at a position away from end portion 27 of cylindrical wall portion 20 toward the side farther from the stage. For example, transparent member 50 may be provided inside cylindrical wall portion 20. Transparent member 50 may be disposed in contact with an end portion (an upper end portion) of cylindrical wall portion 20 so as to directly lid the end portion of cylindrical wall portion 20.

Transparent member 50 is formed of a member that allows laser light to pass therethrough. Transparent member 50 suppresses passage of the dust that is produced by the laser processing from the side closer to stage 60 through inner space S1 toward the side farther from the stage, and arrival of the dust at irradiation unit 40.

### (Second Opening 22)

With reference to FIGS. 1 and 2, as has been described above, cylindrical wall portion 20 has second opening 22. Second opening 22 is provided through cylindrical wall portion 20 at a position on the side closer to stage 60 than transparent member 50 is. Laser processing apparatus 100 has second opening 22 in a shape that opens at end portion 27 of cylindrical wall portion 20. In other words, second opening 22 is formed to have a length or a shape that reaches end portion 27.

Second opening 22 having a longer shape may be provided through cylindrical wall portion 20 at a position on the side closer to stage 60 than transparent member 50 is. For example, second opening 22 may be formed so as to reach an end portion 29 of cylindrical wall portion 20 opposite to end portion 27. As shown in FIG. 1, even second opening 22 having such a configuration will also be provided on the side closer to stage 60 than transparent member 50 is.

### (Function and Effect)

FIG. 5 is a schematic cross section of laser processing apparatus 100 while applying laser processing. The method for manufacturing a laser processed product comprises using laser processing apparatus 100 to irradiate workpiece W disposed on stage 60 with laser light L.

When laser processing apparatus 100 irradiates workpiece W with laser light L to apply laser processing thereto, workpiece W produces fine dust. In particular, when a polymer material such as resin or rubber is processed, it produces gas, dust, and the like and may thus contaminate workpiece W or an interior of the apparatus. The dust may include dust E1 having a relatively large particle size and being heavy and dust E2 having a relatively small particle size and being light.

When heavy dust E1 accumulates on workpiece W or light dust E2 floats in the air, it is difficult to perform high-quality processing. It is preferable to aspirate and remove not only light dust E2 floating in the air but also heavy dust E1 accumulated on workpiece W.

Heavy dust E1 tends to float in a space RR relatively close to workpiece W or adhere to a surface of workpiece W. When laser processing apparatus 100 comprising lid member 10 is compared with the laser processing apparatus without the lid member (i.e., with the channel having cross-sectional area A2), the former, comprising lid member 10 having first opening 11, has a channel with a cross-sectional area (cross-sectional area A1) smaller than the latter does.

As compared with the case where lid member 10 is not used (i.e., with the channel having cross-sectional area A2), the case where lid member 10 is used allows aspiration device 80 to have an aspiration capacity enhanced by first opening 11 and can implement aspiration with a high air velocity in space RR relatively close to workpiece W to aspirate heavy dust E1 and thus efficiently aspirate relatively large and heavy dust E1 through first opening 11.

A distance between bottom plate portion 15 of lid member 10 and workpiece W can be set, as appropriate, and it can for example be about 40 mm. Lid member 10 and/or stage 60 may be configured to be vertically movable so that lid member 10 can approach workpiece W to enhance the aspiration capacity through first opening 11. The distance from lid member 10 to workpiece W may be configured to be changeable depending on the thickness of workpiece W.

Relatively small and light dust E2 tends to scatter toward not only space RR relatively close to workpiece W but also a space between workpiece W and lid member 10, and inner space S1. Transparent member 50 suppresses passage of dust E1 (or E2) that is produced by the laser processing from the side closer to stage 60 through inner space S1 toward the side farther therefrom, and arrival of the dust at irradiation unit 40.

Without transparent member 50, then, for example, it is necessary to supply a downflow to prevent dust from reaching irradiation unit 40, whereas laser processing apparatus 100 that comprises transparent member 50 may not be provided with a mechanism for generating such a downflow.

If cylindrical wall portion 20 should not be provided with second opening 22, and dust E1 (or dust E2) enters the space between workpiece W and lid member 10, and inner space S1, in particular, it may be difficult to aspirate the dust through first opening 11.

In contrast, laser processing apparatus 100 has cylindrical wall portion 20 provided with second opening 22. Therefore, dust E1 (or dust E2) scattered toward the space between workpiece W and lid member 10, and inner space S1 can be efficiently aspirated from inner space S1 located on the side closer to stage 60 than transparent member 50 is through second opening 22 and outer space S2. For example, even when aspiration device 80 having a small aspiration capacity is used, it can perform efficient aspiration.

Laser processing apparatus 100 has second opening 22 in a shape that opens at end portion 27 of cylindrical wall portion 20. Second opening 22 thus configured allows aspiration to be performed at a position closer to stage 60 or workpiece W.

Laser processing apparatus 100 has second opening 22 shaped to extend in the form of a slit from the side closer to stage 60 toward the side farther therefrom. Second opening 22 thus configured allows aspiration to be performed in a wide range in a direction from the side closer to stage 60 toward the side farther therefrom.

Laser processing apparatus 100 has a plurality of second openings 22 provided at positions symmetrical with respect to cylinder axis AX. This configuration allows an aspiration capacity equal about cylinder axis AX. Laser processing apparatus 100 also has a plurality of first openings 11 provided at positions symmetrical with respect to cylinder axis AX. This configuration also allows an aspiration capacity equal about cylinder axis AX.

Laser processing apparatus 100 has top plate member 70 provided with aspiration port 74. The dust aspirated through first opening 11 and second opening 22 travels upward through outer space S2 and subsequently, further moves upward and is exhausted through aspiration port 74. A path is formed to help smoothly exhausting the dust having passed through outer space S2.

### Second Embodiment

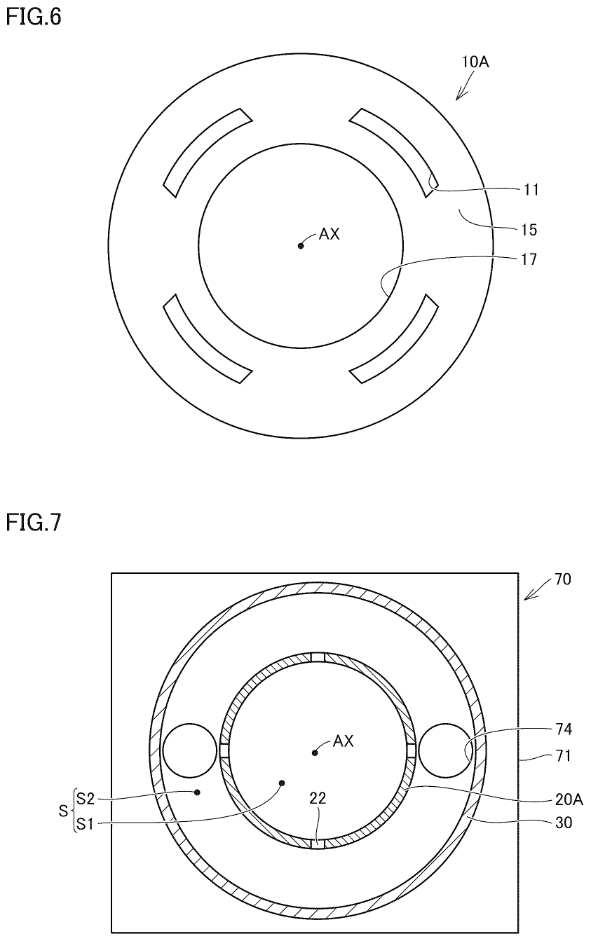

FIG. 6 shows a lid member 10A that a laser processing apparatus comprises according to a second embodiment. Lid member 10A has four first openings 11. The four first openings 11 are provided at positions symmetrical with respect to cylinder axis AX. An even or odd number of first openings 11 may be provided at positions that are point-symmetrical or line-symmetrical with respect to cylinder axis AX.

### Third Embodiment

FIG. 7 shows a cylindrical wall portion 20A that a laser processing apparatus comprises according to a third embodiment. Cylindrical wall portion 20A has four second openings 22. The four second openings 22 are provided at positions symmetrical with respect to cylinder axis AX. An even or odd number of second openings 22 may be provided at positions that are point-symmetrical or line-symmetrical with respect to cylinder axis AX.

### Fourth Embodiment

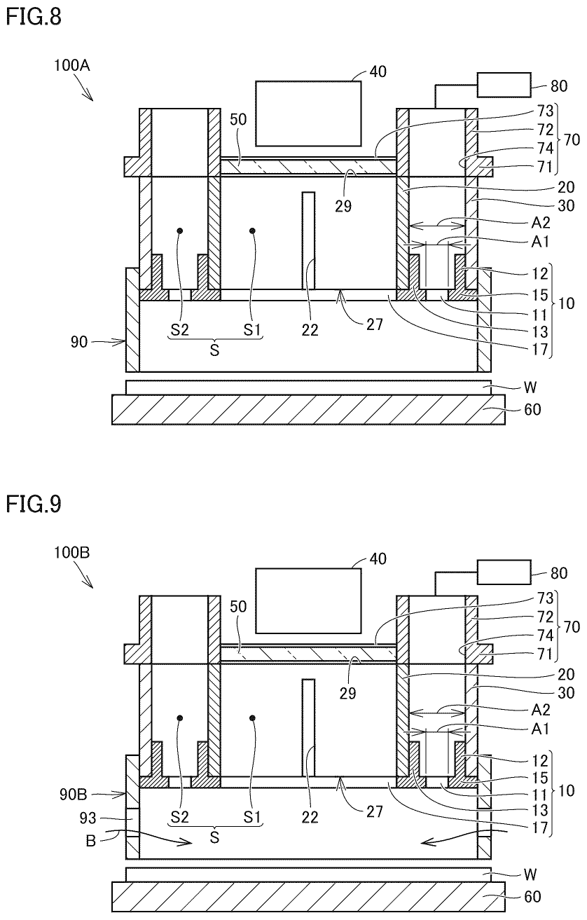

FIG. 8 is a schematic cross section of a laser processing apparatus 100A according to a fourth embodiment. Laser processing apparatus 100A further comprises a surrounding wall 90 in addition to the configuration of laser processing apparatus 100 (according to the first embodiment). Surrounding wall 90 is provided so as to surround a space between lid member 10 and stage 60.

Surrounding wall 90 suppresses arrival of the dust that is produced by the laser processing at an outside of surrounding wall 90 from an inside of surrounding wall 90. A gap between surrounding wall 90 and workpiece W may be reduced to further improve air velocity for aspiration. Surrounding wall 90 may be configured to be vertically movable with respect to the position of workpiece W.

### Fifth Embodiment

FIG. 9 is a schematic cross section of a laser processing apparatus 100B according to a fifth embodiment. Laser processing apparatus 100B comprises surrounding wall 90 with a third opening 93 formed therethrough, and blown air B is supplied from an outside of surrounding wall 90 toward an inside of surrounding wall 90 through third opening 93. Blown air B thus supplied causes dust on workpiece W to float, and furthermore, further suppresses arrival of the dust that is produced by the laser processing at the outside of surrounding wall 90 from the inside of surrounding wall 90. When rubber or the like is processed, workpiece W may be cooled by blown air B to handle melting caused by heat generated during laser processing.

### [Verification Experiments]

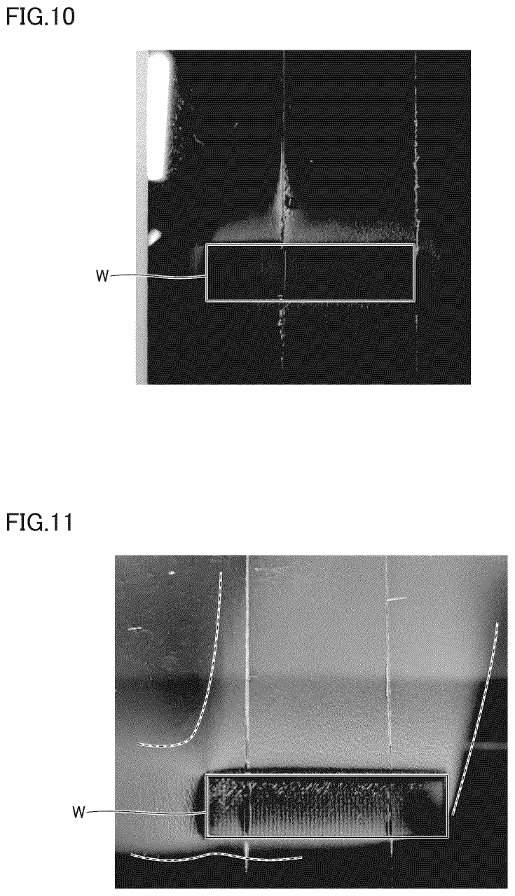

FIGS. 10 and 11 show degrees of scattering of dust on the stage as results of first and second verification experiments, respectively.

The result of the first verification experiment shown in FIG. 10 is based on a case with the FIG. 8 configuration (or laser processing apparatus 100A) applied and an air velocity of 2.4 m/s obtained in a vicinity of workpiece W. FIG. 10 shows dust in white or gray, and it can be seen that substantial removal of dust is achieved in a vicinity of workpiece W.

The result of the second verification experiment shown in FIG. 11 is based on a case with the FIG. 5 configuration (or laser processing apparatus 100) applied without lid member 10 and an air velocity of 0.5 m/s obtained in a vicinity of workpiece W. FIG. 11 shows dust in white or gray. It can be seen that, in a vicinity of workpiece W, residual dust extends long in a direction indicated by a dotted line.

The FIG. 5 configuration (or laser processing apparatus 100) removes dust in an amount larger than the FIG. 5 configuration minus lid member 10 does.

It can also be seen from the results shown in FIGS. 10 and 11 that the laser processing apparatus disclosed in the present specification can perform laser processing while efficiently aspirating dust.

While the embodiments of the present disclosure have been described above, it should be understood that the embodiments disclosed herein are illustrative and non-limitative in any respect. The scope of the present disclosure is defined by the terms of the claims and is intended to encompass any modification within the meaning and scope equivalent to the terms of the claims.

### REFERENCE SIGNS LIST

10, 10A lid member, 11 first opening, 12 outer cylindrical portion, 13 inner cylindrical portion, 15 bottom plate portion, 17 communication hole, 20, 20A cylindrical wall portion, 22 second opening, 27, 29, 37 end portion, 30 outer peripheral wall portion, 40 irradiation unit, 50 transparent member, 60 stage, 70 top plate member, 71 flat plate portion, 72 exhausting portion, 73 hole, 74 aspiration port, 80 aspiration device, 90 surrounding wall, 93 third opening, 100, 100A, 100B laser processing apparatus, A1, A2 channel's cross-sectional area, AX cylinder axis, B blown air, E1, E2 dust, L laser light, RR space, S hollow space, S1 inner space, S2 outer space, W workpiece.

1. A laser processing apparatus that applies laser processing to a workpiece, comprising:
a stage that receives the workpiece thereon;
an outer peripheral wall portion that forms a hollow space inside thereof and is disposed so that the hollow space extends from a side closer to the stage toward a side farther from the stage;
a cylindrical wall portion that has a cylindrical shape and is disposed in the hollow space to sectionalize the hollow space into an inner space located inside the cylindrical shape and an outer space located outside the cylindrical shape;
an irradiation unit that emits laser light so that the laser light passes through the inner space from the farther side toward the closer side and irradiates the workpiece;
a transparent member that is provided so as to close the inner space at a position on the farther side away from an end portion of the cylindrical wall portion located on the closer side; and
a lid member that has a first opening and is disposed so as to close the outer space between the cylindrical wall portion and the outer peripheral wall portion, wherein
the outer space communicates with an aspiration device, the laser processing produces dust, which is aspirated through the first opening and the outer space, and a cross-sectional area of a channel of the first opening is smaller than a cross-sectional area of a channel of the outer space between the cylindrical wall portion and the outer peripheral wall portion, and
the cylindrical wall portion has a second opening at a position on the side closer to the stage than the transparent member is.

2. The laser processing apparatus according to claim 1, wherein the second opening has a shape that opens at the end portion of the cylindrical wall portion located on the closer side.

3. The laser processing apparatus according to claim 1, wherein the second opening has a shape extending from the closer side toward the farther side in a form of a slit.

4. The laser processing apparatus according to claim 1, wherein
the cylindrical wall portion has a circularly cylindrical or rotationally symmetrical shape about a cylinder axis,
the cylindrical wall portion is provided with the second opening, the second opening being a plurality of such second openings, and
the plurality of second openings are provided at positions symmetrical with respect to the cylinder axis.

5. The laser processing apparatus according to claim 4, wherein
the lid member is provided with the first opening, the first opening being a plurality of such first openings, and
the plurality of first openings are provided at positions symmetrical with respect to the cylinder axis.

6. The laser processing apparatus according to claim 1, further comprising a top plate member that is disposed so as to close the outer space between the cylindrical wall portion and the outer peripheral wall portion from above, wherein
the top plate member is provided with an aspiration port, and
the outer space communicates with the aspiration device through the aspiration port.

7. The laser processing apparatus according to claim 1, further comprising a surrounding wall that is provided to surround a space between the lid member and the stage.

8. The laser processing apparatus according to claim 7, wherein
the surrounding wall has a third opening formed therethrough, and
blown air is supplied from an outside of the surrounding wall toward an inside of the surrounding wall through the third opening.

9. A method for manufacturing a laser processed product using the laser processing apparatus according to claim 1, the method comprising irradiating the workpiece disposed on the stage with laser light.
